(19) United States
(12) Patent Application Publication
(10) Pub. No.: US 2005/0119947 A1
(43) Pub. Date: Jun. 2, 2005

(54) Gift recommending method and system

(76) Inventor: Ching-Chi Lin, Taipei City (TW)

Correspondence Address: Dennison, Schultz & Dougherty, 612 Crystal Square 4, 1745 Jefferson Davis Highway, Arlington, VA, 22202-3417, US

(21) Appl. No.: 10/724,718

(22) Filed: Dec. 2, 2003

(51) Int. Cl. G06F 17/60

(52) U.S. Cl. 705/27

(57) ABSTRACT

The present invention provides a gift recommending method and system. By the parameters input by the consumer, and using the powerful computer system and Internet connection, the worldwide members can register or the non-members can surf the present system. According to the preplanned database, the gifts can be recommended after the items that meet the input parameters of the consumer are found in the database, and the consumer can select the specific item from the recommended list. The database includes various product catalogs provided by the factory owners in each region for being selected by the consumer or recommending gifts after the consumer inputs the parameters. The system can inform the provider in the mailed region appointed by the consumer to send the selected gift to the receiver. By the interactions among the system of the present invention, the consumer and the factory owner, the consumer can buy the gift needed by the receiver in a more convenient and economic way.

### BACKGROUND OF THE INVENTION

1. Field of the Invention

The present invention relates to a gift recommending method and system, and particularly to a recommending system for providing specific and suitable gifts by means of the computer system and Internet with the property parameters input by consumers.

2. Description of the Prior Art

Nowadays, the Internet technology is well developed and the global village is formed. In our daily life, the Internet becomes an essential tool gradually. With the change of the life style, the shopping way of people has also changed. To achieve the purpose of rapid and multiple choices, shopping on the Internet has become popular in modern life.

The current shopping ways on the Internet are very similar. The rapidest way is to search the product name that you want to buy on the Internet. If the search result is not what you want, you have to input the related but different product name to search again. Therefore, it takes a period of time to search, and you may not get what you really want or what the receiver really needs. It really wastes time for the modern people who care the time efficiency very much. For the factory owner who provides the products, the purchase rates of the products are also limited.

Therefore, the conventional shopping way on the Internet has many defects, so it is not a good design and should be improved.

Because of the above-described disadvantages generated from the conventional shopping way on the Internet, the applicant keeps on carving unflaggingly to develop the gift recommending method and system of the present invention through wholehearted experience and research.

### SUMMARY OF THE INVENTION

It is an object of the present invention to provide a gift recommending method and system. The gift recommending system can provide the giver to find the favorite gift of the receiver by comparing the property parameters of the receiver (such as the relationship between the giver and the receiver, the budget price of the giver, the gender, age, living area, marriage, origin of the incident, hobby, relationship, gift category and occupation of the receiver) with the preplanned database.

It is another object of the present invention to provide a gift recommending method and system. The gift recommending system integrates the server terminal of the provider, the factory owner, the consumer and the financial institution by the Internet connection to conclude the transaction for the electronic business.

It is a further object of the present invention to provide a gift recommending method and system. The gift recommending system uses member registration system to protect the member's data, and allows the user to input their favorite search parameters for gifts (such as the relationship between the giver and the receiver, the budget price of the giver, the gender, age, living area, marriage, origin of the incident, hobby, relationship, gift category and occupation of the receiver) and open the parameters for the gifts to be searched by members or non-members.

It is an additional object of the present invention to provide a gift recommending method and system. The gift recommending system can be input the received condition parameters by the member and the parameters are opened to be searched by the giver, for example, the receiver, who is a member, can input his desired gift category for his birthday.

It is an additional object of the present invention to provide a gift recommending method and system. The gift recommending system not only provides various shopping choices to the consumer, but also provides the advertisement for the recommended products that are not bought to the factory owner.

It is an additional object of the present invention to provide a gift recommending method and system. The gift recommending system sets a service station in each region for providing services of deliver, maintenance, investigation for gift preferences in specific regions and product packaging, or allocating each regional gift provider to support each other for fast sending the gifts to the receiver.

The gift recommending system that can achieves the foregoing objects includes:
a server terminal providing a distinction operation of client conditions and database system, wherein the distinction operation of client conditions manages the users on line by member registration system, and the database system includes various gifts that meet the needs of the user and are selected by the parameters input by the user;
a user terminal including all products that connect the server on line for sending out condition requests to the server terminal and receiving the signal returned by the server terminal;
a financial institution for receiving the authorized requests of the server terminal and returning the authorized response signal to the server terminal; and
a regional gift provider for providing various product catalogs to the server terminal and receiving the deliver notice instructed by the server terminal and then sending the product to the place appointed by the user terminal.

By the parameters input by the consumer and the preplanned database, the gifts can be recommended after the items that meet the input parameters of the consumer are found in the database, and the consumer can select the specific item from the recommended list. The database includes various product catalogs provided by the factory owners in each region for being selected by the consumer or recommending gifts after the consumer inputs the parameters. The system can inform the provider in the mailed region appointed by the consumer to send the selected gift to the receiver. By the interactions among the system of the present invention, the consumer and the factory owner, the consumer can buy the gift needed by the receiver in a more convenient and economic way.

### BRIEF DESCRIPTION OF THE DRAWINGS

The drawings disclose an illustrative embodiment of the present invention that serves to exemplify the various advantages and objects hereof, and are as follows:

FIG. 1(A) shows the frame of the gift recommending system of the present invention;

FIG. 1(B) shows the block diagram of the gift recommending system;

FIG. 2 shows the main flow chart of the gift recommending method;

FIG. 3(A) shows the detailed flowchart of the gift recommending method; and

FIG. 3(B) shows the detailed flowchart of the gift recommending method.

### DETAILED DESCRIPTION OF THE PREFERRED EMBODIMENT

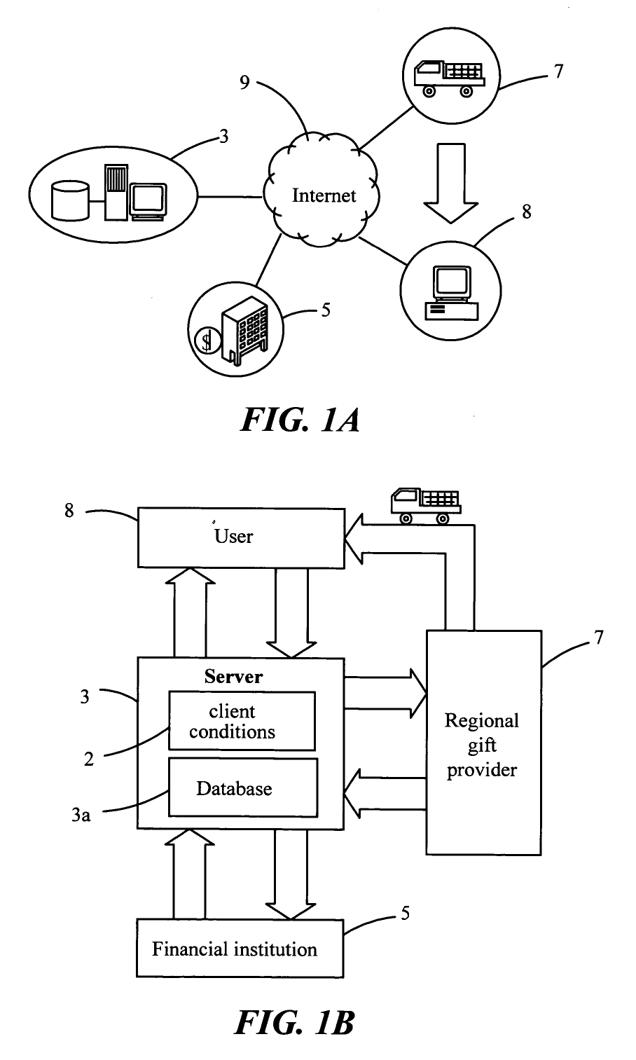

Please refer to FIG. 1(A) showing the frame of the gift recommending system provided by the present invention. As shown in FIG. 1(A), the gift recommending system of the present invention includes a server terminal 3, a user terminal 8, a financial institution 5 and a regional gift provider 7, and uses the Internet 9 as the connection path to conclude the transaction for the electronic business.

Please refer to FIG. 1(B) showing the block diagram of the gift recommending system provided by the present invention. As shown in FIG. 1(B), the gift recommending system of the present invention includes:

(1) A server terminal 3: It includes the distinction operation of client conditions 2 and database system 3a. The distinction operation of client conditions manages the users on line by member registration system, and the database 3a includes various gifts that meet the needs of the user and are selected by the parameters input by the user.

(2) A user terminal 8: The user can send out condition requests to the server terminal 3 by any kind of internet access, and receive the signal returned by the server terminal 3.

(3) A financial institution 5: It receives the authorized requests of the server terminal 3, and returns the authorized response signal to the server terminal 3.

(4) A regional gift provider 7: It provides various product catalogs to the server terminal 3, and receives the deliver notice instructed by the server terminal 3 and then sends the product to the user terminal 8.

The forgoing system further includes a service station in each region. The service station can provide services of deliver and maintenance, or package the products, or investigate the gift preferences in specific region to allocate the circulation of the gifts. In addition, if the gift provider of a certain region has problems and cannot timely send the gifts for that region, the gift provider of that region, after he knows the condition, can coordinate other providers to provide necessary supports for fast sending the gifts to the receiver, so as to keep the good reputation on the market.

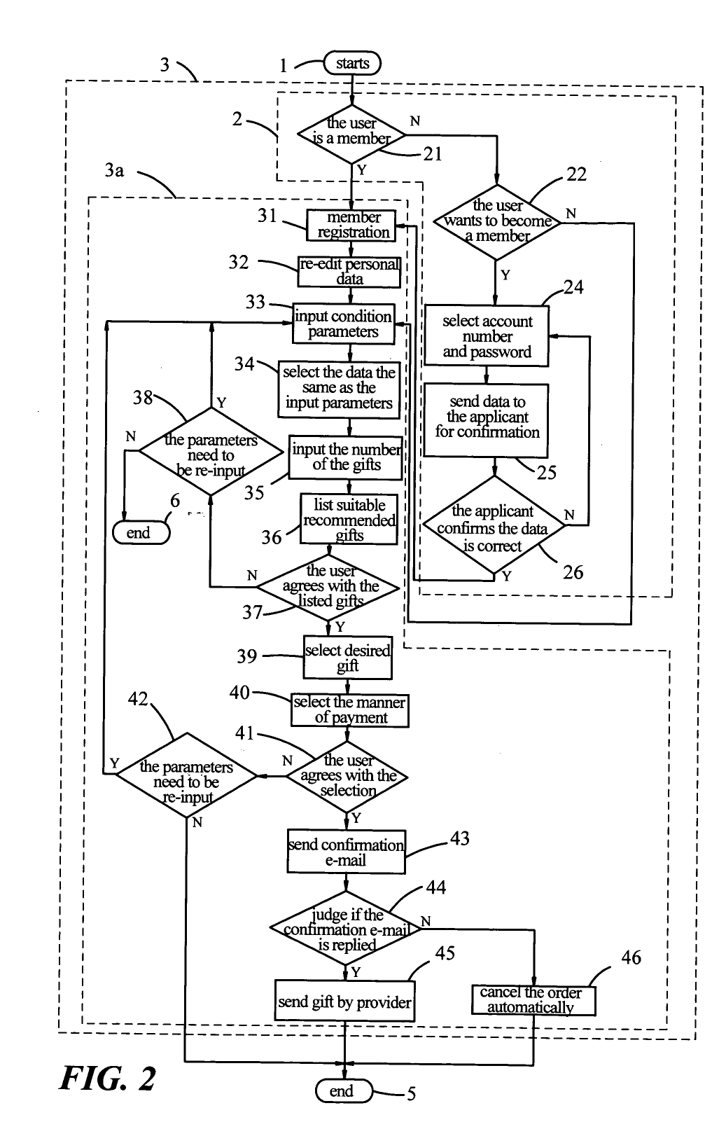

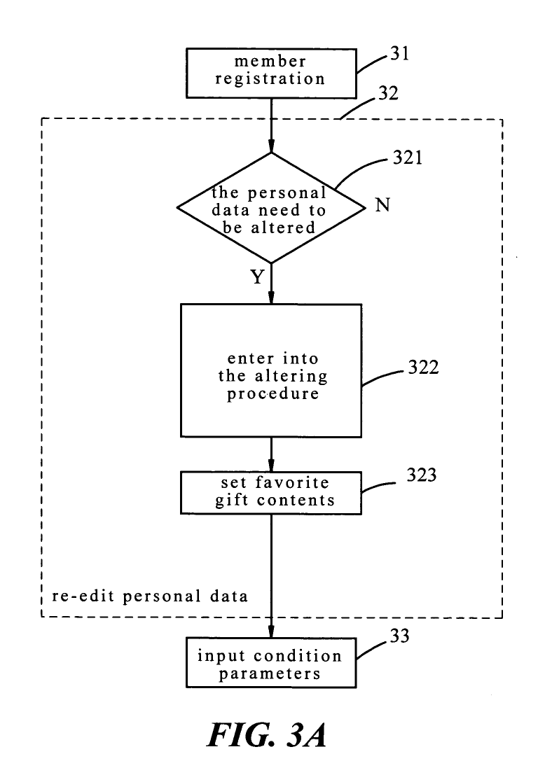

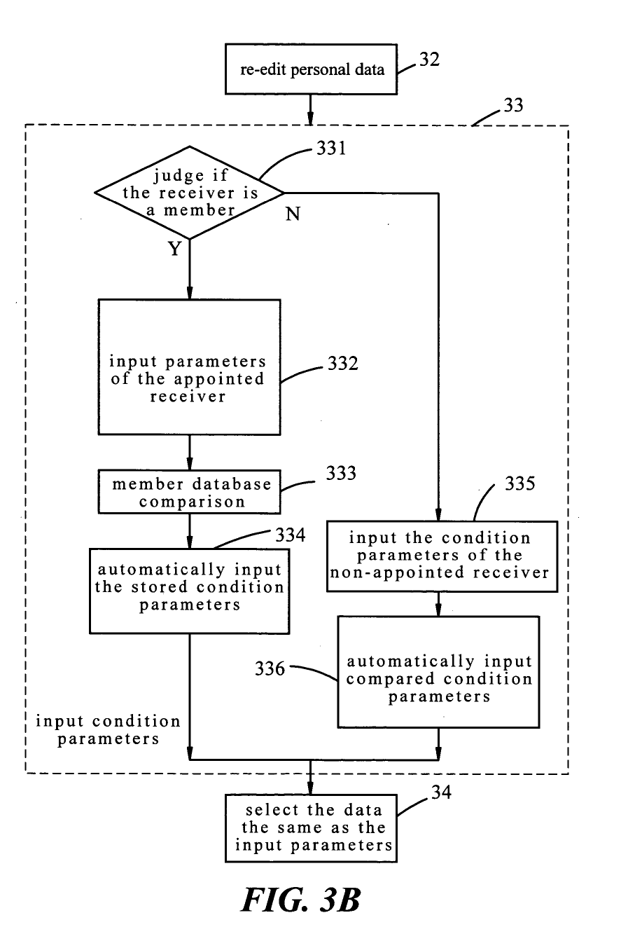

Please refer to FIG. 2 showing the flow chart of the gift recommending method provided by the present invention. As shown in FIG. 2, when the system starts 1, it will enter into the distinction operation of client conditions 2 to judge if the user is a member 21. If he is, the system will request the member to register by his account number 31. If he is not, the system will ask the user if he wants to become a member 22. If the answer is no, the system will leave the registration state 31; if the answer is yes, the system will request the user to input basic data property parameters, and select the account number and password 24. After that, the system will send the personal data, account number and password to the applicant by e-mail for confirmation 25. Then the applicant confirms if his data are correct. If they are not correct, the system will request the applicant to re-input his basic data property parameters, and select the account number and password 24; if they are correct, the system will request the member to register by his account number 31 and if he wants to re-edit his personal data 32. Please refer to FIG. 3(A) showing the detailed flowchart. First, the system will judge if the member wants to alter his personal data 321. If the answer is no, the system will enter into the condition parameter input state 33; if the answer is yes, the system will enter into the alteration procedure (including altering the member data and selecting search parameter items which are publicly accepted) 322. Then the member can set his favorite gift contents directly 323 and enter into the condition parameter input state 33. Please refer to FIG. 3(B) showing the detailed flowchart. First, the system will judge if the receiver is a member 331. If he is, the system will request to input the appointed receiver's parameters (including the name, account number, ID etc.) 332, and through the member database comparison, the database server will automatically input the required condition parameters 334 according to the stored data of the receiver. If he is not, the system will request to input the property parameters of the non-appointed receiver 335; then the database server will compare the property parameters of the receiver and automatically input the condition parameters of the compared result 336. After that, the procedure goes back to the main flowchart in FIG. 2. The database selects the data that meet the input parameters 34; the user inputs the gift number that he wants to list 35; the system lists the recommended gifts of desired list number; then the system asks if the user satisfies with the listed gifts 37. If the user is not satisfied, the system will judge if it is needed to re-input the parameters 38; if not, the procedure is over 6. If the user is satisfied, the user can select the desired gifts (can be multiple choice) 39, and select the manner of payment 40. The system will judge if the user confirms his choice. If he doesn't, the system will judge if it is needed to re-input the parameters 42; if he does, the system will send a confirmation e-mail 43. Then the system will judge if the confirmation e-mail is replied 44. If it is not replied, the system will automatically cancel the order 46, and the procedure is over 6; if it is replied, the system will inform the provider of the mailed region that the user appointed to send the gift 45, and the procedure is over 5.

The input property of the gift recommending method can be designed according to the needs. Please refer to Table 1 showing the tree-like figure of the parameters. The property parameters include the gender, age, living area, marriage, origin of the incident, hobby, relationship, gift category, gift price, occupation of the receiver, and so on. In addition, with the computer system, the present invention can design visualized parameter input menu. The user can input the budget price directly in the pull-down window of the page. The receiver's parameters can be entered into the preplanned database through the parameter item. Then the items that meet the input parameters of the consumer can be found in the database, so the gift recommending is completed.

Compared with the prior art, the gift recommending system provided by the present invention further has the following advantages:

1. The consumer does not need to spend much time finding a particular gift. The consumer can only input the specific parameters of the receiver and select the desired gift from the list recommended by the present system.

2. The present system can automatically and more humanistically pick out the receiver's favorite gift according to the input parameters. In addition, the recommendation will be different with respect to the different regions, and will contact the provider at the receiver's region to send the ordered gift.

3. After the consumer makes the selection from the recommended products, the other products can be regarded as free advertising items for the factory owner.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

TABLE 1
The property parameters of the gift recommending method of the present invention

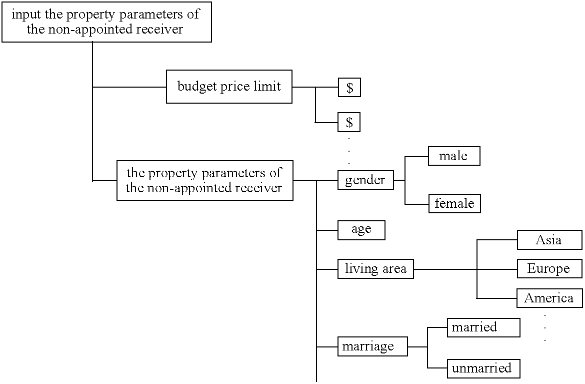

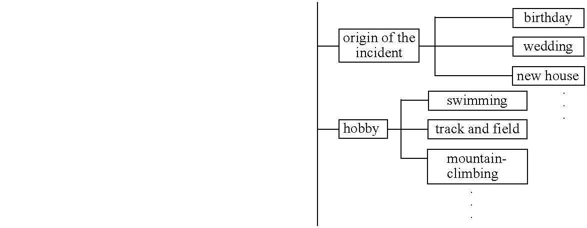

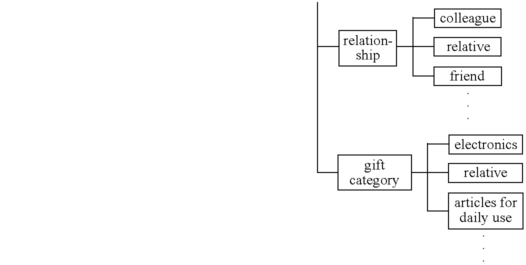

1. A gift recommending method, comprising the steps of:
a. inputting parameters to a computer system by a consumer according to his needs;
b. searching for gift items that meet said needs of said consumer by said computer system according to a preplanned database, and recommending gifts to said consumer;
c. automatically contacting proper provider by said computer system according to the receiver's data to send said gift to said receiver, after said consumer selects said gift.

2. The gift recommending method according to claim 1, wherein the receiver's expected gift is input by himself and after the search in the database, the result is transmitted to the giver, so that said giver gives the proper gift to said receiver in a most economic way.

3. The gift recommending method according to claim 1, wherein said database is built by the planner to collect, classify and connect the product catalogs of each factory owner, or open the limits of authority for willing factory owners to provide optimal products, and manage the safety by said planner.

4. The gift recommending method according to claim 1, wherein said parameter is mainly the price of said gift, and said gifts are recommended after the items that meet the budget price of said consumer are found in said database.

5. The gift recommending method according to claim 1, wherein said parameters include the gender, age, living area, marriage, origin of the incident, hobby, relationship, gift category, gift price and occupation of the receiver, and by said parameters and said preplanned database, said gifts are recommended after the items that meet the input parameters of said consumer are found in said database.

6. A gift recommending system, comprising:
a server terminal providing a distinction operation of client conditions and database system, wherein said distinction operation of client conditions manages the users on line by member registration system, and said database system includes various gifts that meet the needs of the user and are selected by the parameters input by the user;
a user terminal including all products that connect said server on line for sending out condition requests to said server terminal and receiving the signal returned by said server terminal;
a financial institution for receiving the authorized requests of said server terminal and returning the authorized response signal to said server terminal; and
a regional gift provider for providing various product catalogs to said server terminal and receiving the deliver notice instructed by said server terminal and then sending the product to the place appointed by said user terminal.

7. The gift recommending system according to claim 6, wherein said system sets a service station in each region for providing services of deliver, maintenance, investigation for gift preferences in specific regions and product packaging, or allocating each regional gift provider to support each other for fast sending the gifts to the receiver.
